(19) United States
(12) Patent Application Publication
(10) Pub. No.: US 2005/0266388 A1
(43) Pub. Date: Dec. 1, 2005

(54) System and method for online collaboration in a learning environment

(76) Inventors: Mark Gross, Burlingame, CA (US); Thomas Edward Burns, San Francisco, CA (US)

Correspondence Address: ROSENFELD LAW CORPORATION, 2165 FILBERT STREET, SUITE 200, SAN FRANCISCO, CA, 94123, US

(21) Appl. No.: 11/120,542

(22) Filed: May 2, 2005

Related U.S. Application Data
(60) Provisional application No. 60/567,032, filed on Apr. 30, 2004.

(51) Int. Cl. G09B 3/00

(52) U.S. Cl. 434/350; 434/323; 434/362

(57) ABSTRACT

A system and method is provided for the collection and automate dispatching of assignments and news from a teacher to their students and parents. This involves registering members and assigning them roles, scopes and groups based on scheduling and other data pulled from the school/district's database, capturing assignment data from the teacher or student assistant through a web form, constructing custom homepages and assignment messages for each student and parents, and transmitting those messages to the right parties. Additionally, a system and method for relationship-based messaging between members to facilitate communication made difficult or impossible in a traditional school environment. This involves assigning roles and defining the relationships between those roles (factoring in scheduling information), granting and limiting publishing scope based on the same, and providing a system for web messaging and email distribution. Finally, a system and method for creating student digital portfolios. This involves aggregating information already published to the system along with grades and attendance information pulled from the SIS, student work submitted through digital dropboxes, plans and comments from teachers and staff, membership data, and school participation data as expressed through membership and messaging through the system. This information is available on a single web page accessed through directories, rosters and special groups by school and district staff.

### RELATED APPLICATIONS

This application claims priority to Provisional Application No. 60/567,032 filed Apr. 30, 2004, which is herein incorporated by reference.

### FIELD OF THE INVENTION

The present invention relates generally to online collaboration in a learning environment, and more particularly to the management of online collaboration between students, parents, teachers and other school staff.

### BACKGROUND OF THE INVENTION

Every public school in the United States today is under pressure to measurably improve student performance. In response, schools are adopting new technologies and experimenting with different types of reforms. Millions of dollars are available from the government, private foundations, and industry to help schools meet their goals. No Child Left Behind legislation ties Federal funding to improved performance. The Gates Foundation has donated over $373 m to support “Small School” initiatives. Companies like Intel and others aggressively support the integration of technology in schools.

The scale of these initiatives reflects the size of the public school system. In 2001, 47.7 million students attended public schools in the United States; 13.6 million of those were in public high schools (grades 9 through 12) and 11.1 million were in middle school (grades 6 through 8). In California high schools alone, 2004 enrollment projections exceed 1.9 million. A full set of figures and projections are available on the Department of Education (DOE) web site.

The system of the present invention improves student performance by bringing students, teachers and parents into the group. The system addresses three problems:
the design flaws of existing school web and communications systems.
the difficulty large, comprehensive schools have in mirroring the achievement gains of the “Small School” reform movement.
the structural and cultural barriers that interfere with communication and collaboration among teachers, parents and students.

While schools have made great strides in adopting technology, parents and teachers remain isolated and disconnected from each other and the information they need to manage an individual student's success. According to the DOE's NCES (National Center for Education Statistics), in 2002, 99% of all public schools in the U.S. had Internet access. In 2002, the ratio of students to instructional computers with Internet access in public schools was 4.8 to 1, up from the 12.8 to 1 ratio in 1998, when first measured.

School districts are rapidly adopting central systems to manage student information, track attendance, and build and manage schedules. In response to legislation like No Child Left Behind, they are adopting data integration packages that allow administrators to track progress on a school-wide basis. They are encouraging teachers to use digital grade books, and to incorporate technology into the curriculum. They are building web sites and encouraging teachers to post information like homework and assignments.

Schools are at the early stage of the technology adoption curve traced by the private sector. Back-office areas like accounting got technology first, but eventually disruptive technologies like email and the Internet led to a breakdown of isolated departments, to supply chain integration and customer relationship management, to web-based business models and information services. In response, corporations dropped their inwardly focused rigid hierarchies and became decentralized organization with transparent boundaries.

Schools are in a position to sprint up this curve; the basic technologies they need exist and are well understood as are their benefits. However, schools are among the most moribund of public institutions. Forces encouraging rapid innovation grind against significant acceptance and implementation issues. The typical Internet strategy of most schools shows these forces at work.

School web strategy is mostly about publishing school-related content rather driving student performance. That is because they are organized around themselves rather than their students and the needs of people with a stake in the student's success—their parents, their current teachers, and school administrators.

As a result, the home page of a school web site typically includes general information and access to tools like staff directories. They do a good job of getting visitors general news and information, but a poor job of providing student-centered information—the homework of a particular student, their grades, attendance history and other performance metrics, easy tools to allow various communities to connect—for example, a simple way for a parent to contact all their child's teachers.

Instead, the sites are top-down information hierarchies that require users to mine them for information that may or may not be there. That is because many rely on teachers to create the sort of dynamic content most valuable to parents and students. For example, a parent trying to find homework on a school's web site is forced to hunt first for all the teachers (first they have to know all their names), then drill down into their web pages.

The design and scope of those pages is often left to the teacher. As a result, there is little consistency from page to page, and information if often outdated if available at all. Any but the most diligent parent forced to deal with this likely gives up. This is both a design and implementation problem: Teachers are too busy to make a priority of designing and updating web sites. They don't see the process as worth the time—even if they had the tech skills to do the job efficiently.

In addition to a web site, a school's Internet strategy should address communication. Most schools have email but fail to look at email and the web as an integrated communication system that can link various groups in meaningful combination. Parents, for example, cannot easily email the teachers of all their students. Students cannot easily email people in their classes to discuss assignments. Teachers cannot easily identify their students' other teachers, limiting opportunities for collaboration.

In short, while schools have made notable strides in automating some processes, acquiring Internet connectivity, putting up basic web sites, and adopting email, they have not developed an integrated strategy for putting these tools to work to drive student performance.

Adopting successful school reform movements to large, comprehensive schools has not worked. The Small Schools Movement (Small Schools), proven successful for over fifteen years, is too staff intensive and thus too expensive for most public schools. Small Schools believe that smaller learning environments dramatically improve student performance. Unfortunately, these schools have higher operating costs than their large-school kin—higher administrative costs and a greater teacher-to-student ratio than is affordable in most publicly financed school settings.

In response, large, comprehensive schools have tried to adopt Small School principles by creating “small learning communities” on their campuses. This transition is working with varied success—outside of cultural issues, it is difficult to recreate the intimacy and collaboration critical to small schools without the staff. Additionally, pressure to offer a wide variety of courses, to satisfy the scheduling needs of a large student body, and work within teacher contract limitations makes it difficult to realize this objective.

While small school proponents argue that schools should be organized around a small cohort of students, and that teachers should collaborate among themselves and with parents for the success of each individual student, school structure and culture and structure make adopting these reforms difficult. Schools are organized around inward-facing departments. Teachers see students as customers of their department—an English student or a Math student, but rarely as a whole student. Departments compete for resources, tend to be located physically apart, and rarely, if ever, work on collaborative programs.

Teacher-to-teacher contact tends to be department-based. When there are problems, they deal directly with the administrators or with the parents, but again rarely are there cross-departmental conversations about a student. Even if teachers wanted to, there is no simple way to determine who teaches who, no easy way to communicate.

It is not surprising that students get lost in this model; no one in the school is accountable for them overall or collaborates for their success: No one owns the whole, individual student. However, the parents do. Parents see their kids as whole people, but are left out of the group on about what happens in school. Their only source of information, their kids, don't tell them. Parents can try to get the information from their school web site. But, as noted earlier, easier said than done. Even if a parent is lucky enough to find a single who has posted current information, they need to then repeat that process four, five, maybe even six times. Who has the time!

Contacting teachers is equally as frustrating. In high school, a student may have seven different teachers, some of whom change at semester break. Schools don't offer a simple protocol for finding a given teacher, nor do they offer a simple way that a parent can contact all their kid's teachers. Generally, the same holds true for attendance and grade information—it is often in the system but it takes far too much work to get at it for most parents.

### SUMMARY OF THE INVENTION

The present invention includes a system and method for online collaboration in a learning environment involving students, parents and teachers.

The system of the present invention is designed to improve student performance by bringing students, teachers and parents into collaborative groups. By creating these groups, the system addresses three important problems:
the design flaws of existing school web and communications systems.
the difficulty large, comprehensive schools have in mirroring the achievement gains of the “Small School” reform movement.
the structural and cultural barriers that interfere with communication and collaboration among teachers, parents and students.

In one aspect of the invention, a system and method is provided for the automated creation and dispatching of assignments and other school related information on a custom basis from teachers to their students and their parents in a school environment. This aspect involves creating membership accounts for parents and students, associating those accounts with a student ID, relating that ID to schedule and performance related data pulled from the school/district's student information system (SIS), capturing assignments, news, and discussion threads through web page forms, storing and sorting that data, assembling a custom homepage with pertinent information for each student and parent, and sending a copy of the information to the student and parent's email address.

In another aspect of the invention, a system and method is provided for relationship-based messaging, in which members, based on their roles, and a set of predefined and custom scopes, can send messages to one another based on their relationship to one another, rather than just to an known identity. This aspect of the invention involves defining groups of users and assigning them certain roles based on a school environment, and predetermining a set of communication scopes that grant and limit the right to transmit messages.

In another aspect of the invention, a system and method is provided to aggregate information about a student into a digital portfolio, provide access to the portfolio to teachers and staff, and give them a set of collaborative tools to access, review, discuss, communicate and plan for that student's success. Some of the data, like grades and attendance, is pulled from the school/district's SIS. Other data entered using web forms by teachers, students and staff, including assignments, news and discussion. This information is used elsewhere but also sent to the portfolio. Still other data includes assignments turned into the teacher by students through a digital drop box provided by the system that in turn is made part of portfolio. The system itself pushes data like the student's membership information and other members in their group (parents, teachers, etc.), and their involvement in other school related functions and activities hosted by and tracked by the system including online groups for clubs, teams and so on, as well as participation in online discussion. Finally, staff can publish documents toward an education plan, including ongoing commentary and discussion. Information in the plan and work sample stays resident throughout the student's school career and membership in the system.

The present invention has other objects and advantages, which are set forth in the description of the Detailed Description of the Invention. The features and advantages described in the specification, however, are not all inclusive, and particularly, many additional features and advantages will be apparent to one of ordinary skill in the art in view of the drawings and specification herein.

### BRIEF DESCRIPTION OF THE DRAWINGS

FIG. 1 is a block diagram of the system of the best mode of the present invention.

FIG. 2 is a flow chart of the assignment message system.

FIG. 3 is an exemplary student homepage.

FIG. 4 is a table of the groups and roles in the system.

FIG. 5 is a flow chart of student digital portfolio system.

### DETAILED DESCRIPTION

### Overview

The system of the preferred embodiment drives student performance by keeping the people who care most about an individual student's success—the parents and the students themselves—in the loop with their teachers and their classmates. The system makes that happen by providing custom, individualized web portals and email communities for students, parents, and teachers.

There are several groups in the system. A primary group contains a student, their parents and their teachers. Another group contains a student and all the other students who share a class with that student. Yet another contains a teacher and all the teachers who instruct that student. People who are in a group have the right to email all the members of the group; people who are not in the group cannot.

Each member accesses their group email either through their own email box that they maintain, or through a single archive on their private, custom home page. Parents and students receive at least one email a day, though, containing currents assignments and news related directly to the member and links that allow for easy-email to other group members and links to web destinations like grade books and web sites. This “push” system solves the problem of parents and students having to fetch the information they need or having to struggle to make contact with the right people.

Teachers have more views than parents or students. By default, they are part of more groups and have a stake in all their students' progress. Teachers can view the roster of either one class or all of their classes. This roster view gives them email connections to students and parents alike. They can also drill down to an individual student, see their digital portfolio that includes their schedule, work samples, performance, and tools to contact the student, parents, and teachers of the student.

In addition to a list of other teachers involved with the student(s), teachers see all the assignments posted by other teachers. This information and the ability to easily communicate across departmental borders encourages collaboration—a teacher seeing that another is covering Martin Luther King may offer to share lesson plans or run a joint activity.

Unlike current web systems for schools, the system works with minimal teacher participation. So long as teachers are willing to answer email from parents or students, something they do today, the system can function without their active participation. Though this is not desirable, it means that early stage adoption will not rely on teachers radically changing their behavior.

The system accomplishes this by gathering most of its data from existing databases at the school or district level. That data is imported daily and the various groups and web pages are adjusted dynamically. Gathering daily homework information is accomplished either by the teacher submitting the information through a web form or through a network of students who work as a teacher assistant (a TA) for a teacher or a group of teachers.

The TA is a common role in schools. The system extends the TA role to the Internet by recruiting students to post homework for the classes they currently attend. Since students have multiple teachers, a small number can cover all the classes for a given grade level. Additionally, the system will recruit students who speak a native language other than English to provide translations for parents to function, this system does require limited participation minimally by the administration of the school to encourage teachers to name TAs. But again, that is such a benign chore and one within the tradition bounds of a teacher's work, resistance is not anticipated.

Since the email contains dynamic, daily content, it is the perfect medium to put links to the entire network into the hands of users daily. People will slowly migrate to the system as they have a need and remember that they have a copy of an email with all the links they need somewhere on their system.

The system raises student achievement by providing collaborative, communications and data tools to help teachers, parents and students work together for success. Research shows that parental involvement contributes directly to improved student achievement. Small School research also shows that when teachers collaborate with each other and parents, students win.

The system is ultimately the web strategy for schools. Once implemented, it will supplant existing school web site strategies as it absorbs critical information transactions. The system may also provide the ability for teachers to post files for review and download, for example.

From a school administrator's point of view, the system addresses many needs—community relations, increasing classroom transparency and accountability—while driving student achievement. Administrators will receive appropriate reports necessary to monitor and encourage usage.

The system affects performance in some not so obvious ways as well. As people use the system, and as new features are added, information transactions are archived. These transactions are evaluated to see if any are early indicators of changes in performance, up and down. Indices can then be used real-time to monitor students (and teachers) to head off potential problems. They are reported in a digital portfolio, a web page about each student accessible by all staff. This page shows all assignment, the names and contact information of people in the student's group, work sample and an education plan, grades and attendance information, and participation in various school activities online.

Finally, the system provides an information network. So a student's information will migrate with the student from year to year and if they transfer. Indices can be applied from school to school. The network can be used to ease the transition of students form elementary to middle school, and then from middle school to high school as groups can be created and information exchanged to connect teachers who previously never had any way to contact one another.

The system keeps people in the group informed and connected. Thus, people who care about a student's success are in a better position to affect that success, the ultimate goal of schools.

### Implementation

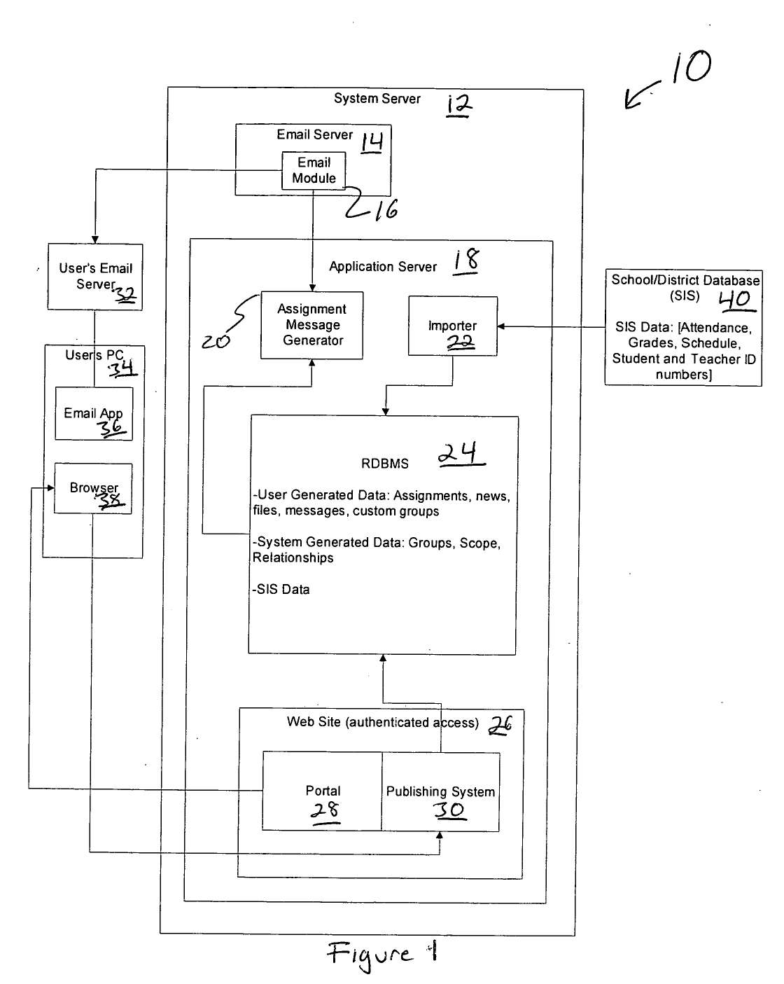

The system 10 of the present invention, depicted in FIG. 1, includes the following system services on system server 12:
An email server 14, containing email module 16.
A web application server 18 containing an assignment message generator 20, database importer 22, relational database management system (RDBMS) 24, and web site 26 (containing portal module 28 and publishing system 30).

System 10 further includes client side components including an outside email server 32 and client computer 34 (or any email and web enabled client device such as a personal digital assistant (PDA)) with email and with a local email application 36 and web browser 38. Typically, system 10 will include many client computers 34 associated with the many users (e.g., students, parents and teachers) that utilize system 10. Each client computer 34 has an associated email server 32 that is typically located at the user's Internet Service Provider (ISP). All email passed between client computer 34 and system server 12 is passed though email server 32, which communicates with email application 36 on client computer 34 via POP3, IMAP, SMTP, and the like, and with email server 14 on system server 12 via SMTP.

System server 12 also provides web access to client computer 34 via HTTP. Web browser 38 on client computer 34 access web pages provided by application server 18 on system server 12. Users receive data from web server 26 via portal module 28 and transmit data to web server 26 via publishing system 30.

System 10 also includes the school/district's student information database (SIS) 40, which is a database maintained by the school or school district containing attendance records, grades, schedules, and student and teacher identification numbers. Application server 18 gathers information from SIS 40 by way of importer 22. The information gathered by importer 22 is stored in RDBMS 24.

For deployments to service a larger number of concurrent users, the system 10 scales to utilize additional servers. For example, each of the listed services above may be deployed on an independent piece of hardware with networked together to provide a coherent solution via TCP/IP.

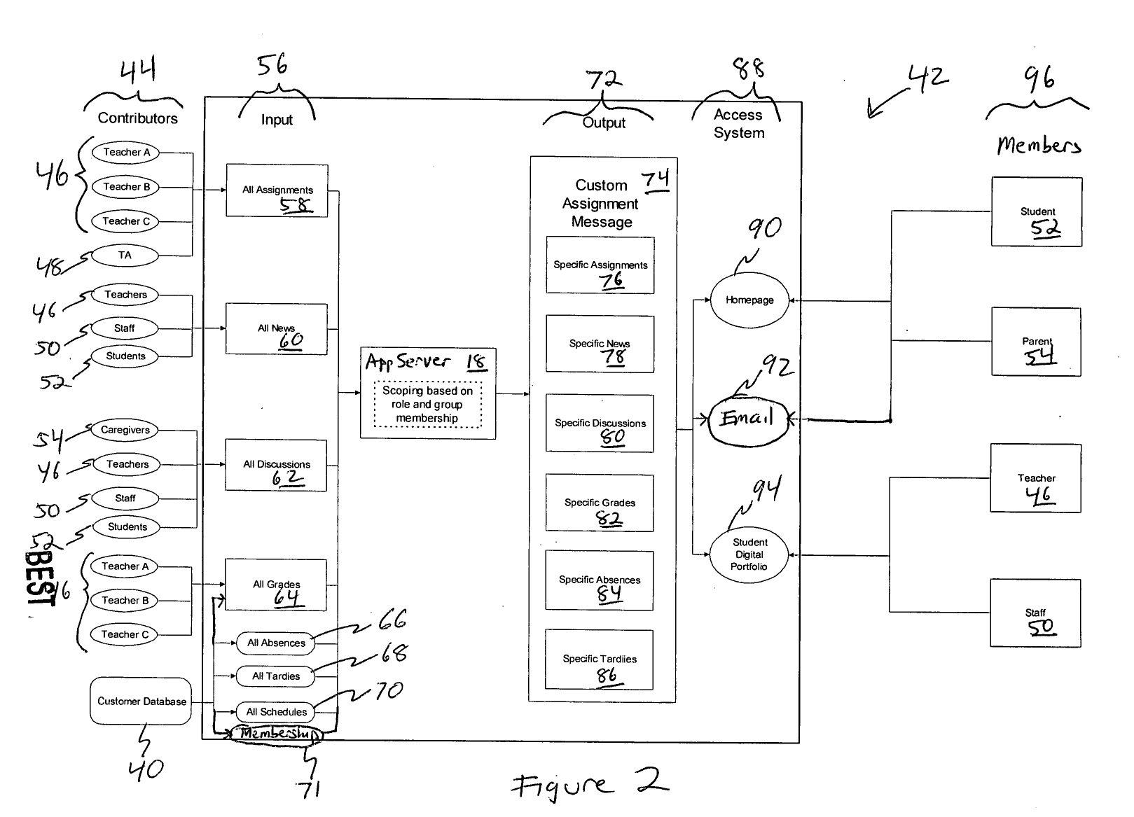

FIG. 2 depicts the functional deployment of the assignment messenger system 42, which is a subsystem of system 10. The messenger system 42 takes inputs from contributors 44 (including teachers 46, teaching assistants (TAs) 48, staff 50, students 52, parents/caregivers 54 and the SIS 40). Additionally, the messenger system 42 relies upon group membership information related information (roles, related scoping rights and limits, and email addresses) stored in database 24. The messenger system 42 uses database 24 to aggregate the right information and provide the information to users though access system 88 (which includes email server 14 for pushing assignment messages and web site 26 for providing web pages).

Every user of the system 10 is a registered member. Registration includes name, email address (if the user has one), and ID number (provided by the school system). Parents 54 register with the ID of their students 52. Members 96 choose a login name but can only publish in their real names. The system 10 assigns their real names based on the information in the SIS 40. This non-anonymity helps prevent abuse.

Every member is assigned a role: student 52, parent 54, teacher 46 or staff 50. Each role has a certain scope for publishing and communicating. For example, students 52 can publish email to other students 52 and teachers 46, and to the groups of which they are members. Teachers 46 and all staff 50 can publish to most members.

People publish to groups, and members are put in predefined groups that include group names for their role (students, teachers, etc.), their grade level, and their courses. New groups can be defined on both a permanent and temporary basis for the purpose of communication and collaboration. An example of a permanent group is the football team or band, a temporary group is a set of members or groups defined by a user for a specific communication, a piece of news or an email.

Information for much of the formation of groups is based on data pulled from the SIS 40. Primarily, this includes schedule information that ties a student and a teacher to a class during a specific period. Parents 54 are tied to their student's groups if their role is given that scope. The data sharing occurs automatically through a software script in application server 18 that interacts nightly with the SIS 40 and communicating back to the application server 18 by email server 14.

All of this information is stored in database 24 on application server 18 and made available to members by access system 88. The information is organized and published to custom homepages 90 by portal module 28 for all members. In addition, at a predetermined time each evening, it is emailed 92 to the students 52 and parents 54 email address by email server 14.

Contributors 44 to the database include teachers 46, teacher assistants 48, school and district staff 50, parents 46, and the SIS 40. Their inputs 56 include assignments 58, news 60, discussion comments 62, grades 64, attendance information (absences 66 and tardies 68), all schedules 70, and member identification information 71 (such as ID number and real name of users). The inputs 56 are processed by application server 18 and stored in database 24 until provided as the output 72 in the form of custom assignment message 74 by access system 88 to users 96.

Assignments 58 are input through a web form. Choices of to whom to publish the assignment 58 are scoped down to the classes taught by the teacher 46. Teachers 46 can publish to any single period as well as to any combination of periods and courses that they teach.

Assignments 58 are given assignment and due dates. Once processed, specific assignments 76 are published every day until they are due. Teachers 46 can provide an estimate of how long an assignment can take, as well as the name and description of the assignment. Teachers 46 can attach files and links to assignments. Files can be of any type or size.

Teachers 46 can also give publishing rights for assignments to student assistants or teacher aides (TAs) 48. Rights also include the scope of publishing; a TA 48 can be given rights as broad as to publish assignments for all a teacher's classes or as narrow as to publish for just one period.

Each specific assignment 76 includes a threaded discussion board 80. Any member 96 who receives the assignment 76 can publish to the associated discussion board 80, asking or answering questions about the specific assignment 74.

The system 10 accepts international characters, and assignments (and all content) can be published in multiple languages. This ensures parents 54 can receive custom assignment messages 74 in their native tongue.

In addition to specific assignments 76, members 96 can publish news 60. Like an assignment, news has an audience scope (from the entire system to as narrow as the members of a small club), a publication and expiration date, a headline and body, the ability to include attachments like files and links, and the ability to allow a threaded discussion. In order to publish news, first a contributor 44 inputs the news 60, which is processed by application server 18 and published as specific news 78. Similarly, any user responding to published news 78 and thus acting as a contributor 44, inputs discussions 62, which are processed by application server 18 and published in the associated discussion thread 80.

Discussions are held among members of a group, whether predefined and permanent, like a team, course or club, or temporary, like the audience for a particular new story. Active discussions 80 are promoted in the assignment message 74 by email 92 and on member homepages 90.

The system 10 pulls grade information 64 from the SIS 40 and teachers 46, and publishes current grades 82 for all courses on each member's homepage 90. Both teachers 46 and the SIS 40 contribute grades 64. Typically, teachers 46 input grades 64 on an assignment basis and the SIS 40 provides final grades 64. Attendance information, including absences 64 and tardies 68, also is input form the SIS 40, and then published as specific absences 84 and specific tardies 86 in custom assignment message 74.

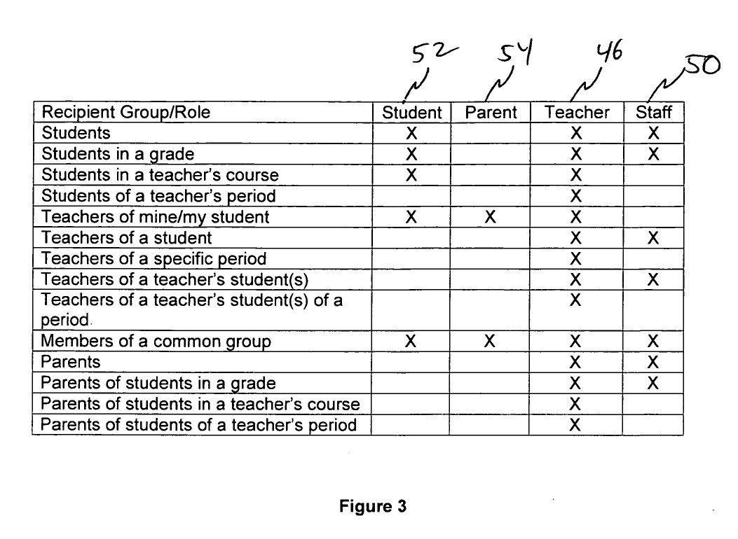

All custom assignment messages 74 are stored for publication in database 24. The custom assignment messages 74 are aggregated and filtered so that each member 96 receive the right mix of information. The information includes the specific assignments 76, news 78, discussion threads 80, grades 82 and attendance information 84/86. That information is output onto a custom, password-protected homepage 90. FIG. 3 depicts and exemplary homepage 90 for a student 52.

The custom assignment messages 74 are also sent in an email 92 each day. The system 10 organizes the most current custom assignment message 74 for each member, packages that information into an html email 92, and addresses that email 92 to the member's address at a predetermined time, typically at 5:00 p.m.

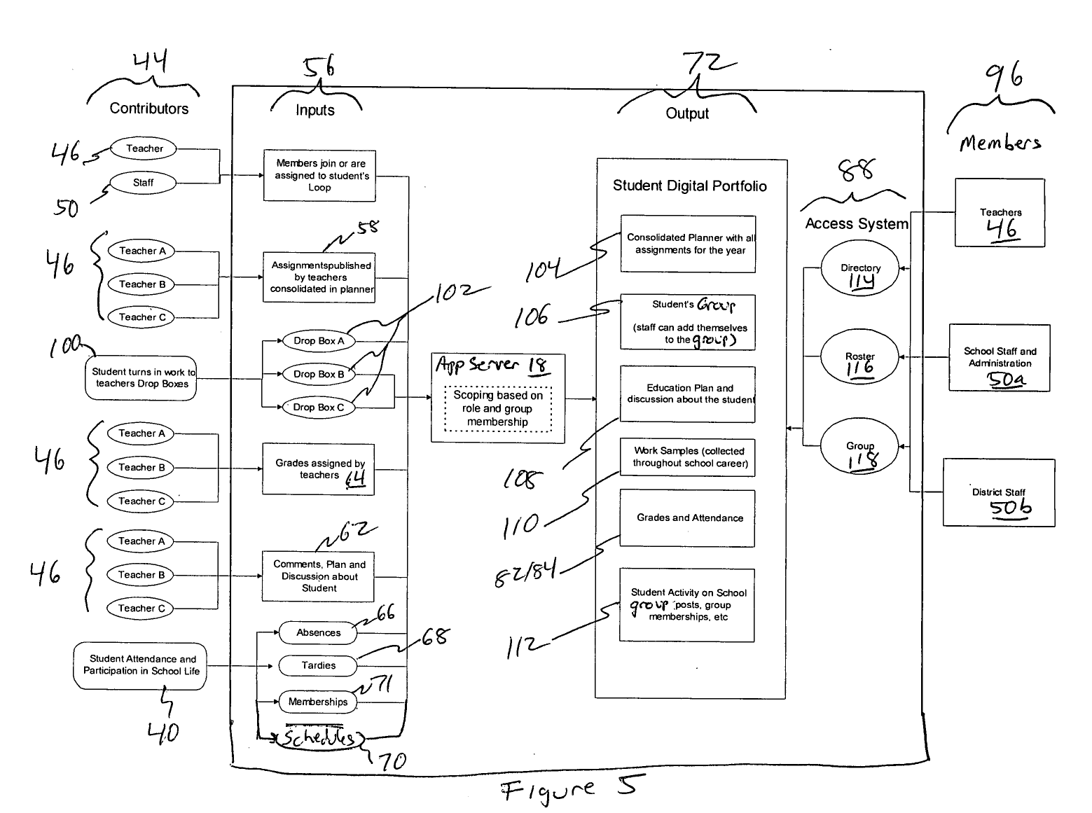

The custom assignment message 74 is accessible by different users though different aspects of access system 88. Students 52 and parents 54 can access it through the daily assignment email 92 and through their custom web page 90. Teachers 46 and staff 50 can access the information for a given student in that student's digital portfolio 94. The portfolio 94 is accessed from the system server 12 by teachers through their roster and by school staff through the school directory. All staff have access to all student digital portfolios 94, which are discussed in detail later in this specification with respect to FIG. 5.

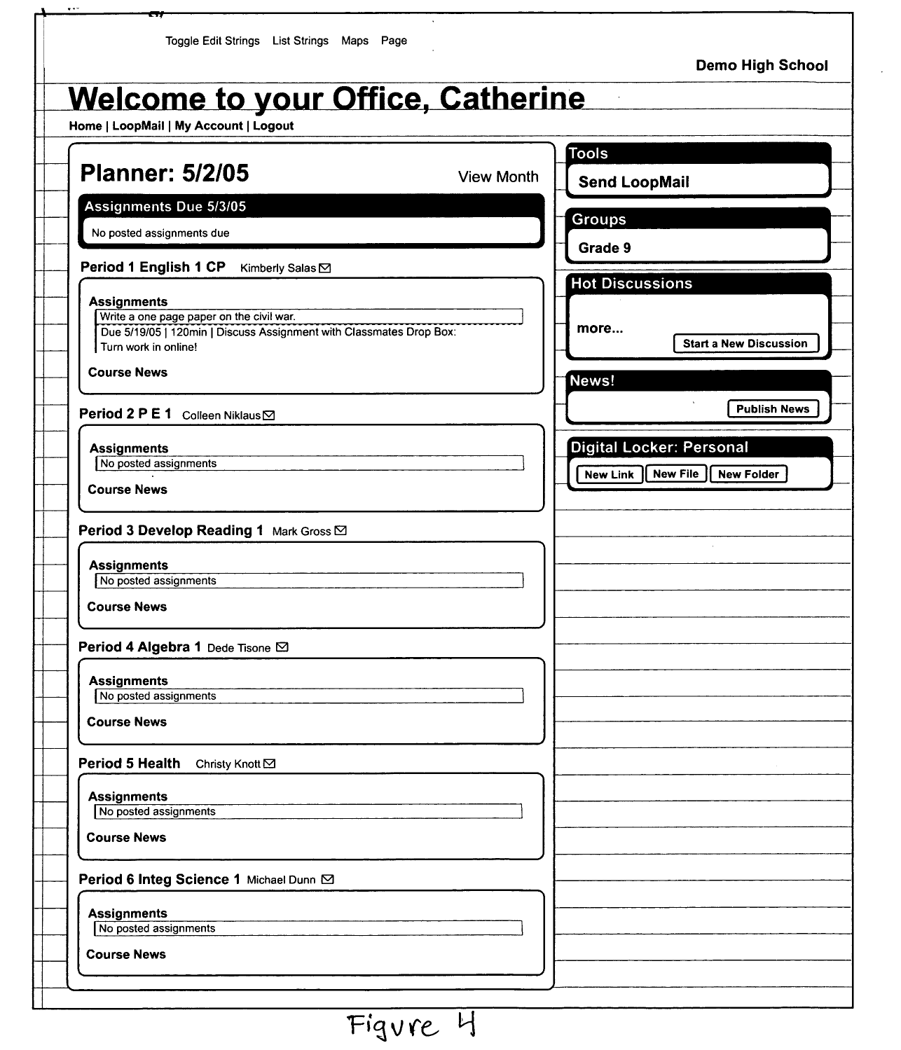

FIG. 4 depicts the groups and roles of the relationship-based messaging system. The system 10 allows for one-to-one and one-to-many messaging through threads and a private network messaging system that to the member 96 looks like email except it uses their real names. It also pushes the assignment messages 74 out-through email server 14 to the email client (email server 32 and email application 36) of members 96.

As described in the section on the assignment message 74, members 96 are assigned roles and scopes based additionally on the groups to which they belong. Because of the particular nature of the school environment, it is possible to define relationships between various combinations of roles and groups, facilitating communication in ways previously so difficult as to nearly be impossible.

FIG. 4 outlines many but not all such combinations. In large comprehensive schools, students 52 have many different teachers 46, and any combination of students 52 in a given class during a given period is generally unique. A given set of students 52 individually may have six teachers 46 each a day, but among them share thirty or more teachers 46.

The communications issues become even more intense for school staff 50 who work with students 52 in non-roster combinations. For example, the coach of a team, leader of an on-campus organization, or a resource specialist assigned a shifting group of students 52 with the need for remedial help in reading.

The relationship-based messaging system resolves these problems by making it easy to communicate with combinations of people based on their roles and relationships to one another. For example, a teacher 46 can use the messaging system to quickly connect with all the teachers of a given student, or all the teachers of their 6^{th} period.

Communicating with all the teachers of a student is essential for schools looking to drive student performance: Teachers must be able to collaborate around their student's success, but in most schools, they don't know who teaches their students because the combinations are nearly infinite.

FIG. 4 outlines many of these combinations, each important and ranging in difficulty today from modest to nearly impossible. This is true not just for teachers 46, but for students 52, parents 54 and school staff 50.

FIG. 5 depicts the functional deployment of the student digital portfolio 94. The portfolio 94 is an aggregated view of the student 52 and is accessible by all school staff 50. It contains in one place a unique mix of information and tools.

Contributors 44 to the student digital portfolio 94 include parents 54, teachers 46, students 52 and school staff 50. Their inputs include their the same information discussed with respect to the assignment messenger system 42, as well as work samples, education plans, and measures of activity input as part of discussions 62. The input information 56 is aggregated and made available in the student digital portfolio 94. The portfolio 94 is based upon much of the same information as custom assignment message 74, but is presented in a different output view 72 geared to a specific student 52. The portfolio 94 also includes a consolidated planner 102, students' group information 106 (staff 50 may add themselves to a student's group), an education plan and discussion 108 about the student 52, work samples 110 collected throughout a student's school career, grades and attendance information 82/84, and student activity 112 on school groups (such as posts, group membership, and the like).

In a similar fashion to the assignment message 74, portfolio 94 aggregates information in database 24 and distributes the information to members 96 based on their identities and roles. The same assignments 76 that a teacher 46 publishes by email 92 and homepage 90 for a set of classes appear in the student digital portfolio 94.

Students 52 are able to turn work 100 into their teachers through the system 10 in digital drop boxes 102. Once turned in, this work 100 is also accessible by all staff through the digital portfolio 94. Additionally, work samples do not delete automatically at the end of a class; they travel with the student 52 from year to year, or from school to school. This longitudinal view of a student 52 is a long-term but rarely realized goal for schools.

As discussed with respect to assignment messenger system 42, teachers 46 submit grades 64 on a periodic basis to the application server 18 and the SIS 40 for distribution in progress reports and report cards. The application server 10 aggregates this information and makes it available to staff 50 for all the student's classes in one place. The same is true for absences and tardies.

The student digital portfolio 94 allows staff 50 to post plans and hold online discussions about the student 52. This centralized collaboration tool is more vital than ever with the increased accountability of schools. By putting the collaboration tool near the information about the student 52, its usefulness is enhanced.

Students 52 participate in school life through the system 10 by joining groups like clubs, teams, study groups, and by participating in discussions and message exchanges. The student life information is input from the SIS 40. The student digital portfolio 94 makes access to that participation accessible to staff 50, rounding out the view of the student 52.

The portfolio 94 is accessed through several systems. All school staff 50a and district staff 50b can access a school directory 114 of every student 52. This leads directly to the portfolio 94. Teachers 46 have a pre-scoped directory called a roster 116 of their students 52, and staff 50 can also access these records through various special groups 118.

From the above description, it will be apparent that the invention disclosed herein provides a novel and advantageous system and method for online collaboration in a learning environment. The foregoing discussion discloses and describes merely exemplary methods and embodiments of the present invention. One skilled in the art will readily recognize from such discussion that various changes, modifications and variations may be made therein without departing from the spirit and scope of the invention.

1. A method of automating the distribution of assignments, news and other content from a teacher and school staff to their students and parents in a school environment comprising the steps of:
storing membership data including email addresses;
gathering system data from a student information system;
capturing assignment data from the teacher through a web form;
storing the assignment data;
constructing a custom web page for each student and parent based upon the assignment data and the system data;
constructing a custom email assignment message for each student and parent based upon the assignment data and the system data; and
transmitting the message to the students and parents via email.

2. The method recited in claim 1, wherein the custom web page and the custom email assignment message for the parent is constructed in the native language of the parent.

3. The method recited in claim 1, wherein the data from the student information system is comprising student identification numbers and schedule information.

4. A method of allowing relationship-based messaging that facilities communication and collaboration across traditional boundaries in school environments, comprising the steps of:
defining a set of user roles and user groups;
assigning a user to a user role and one or more user groups;
defining a set of relationships between the user roles and the user groups unique to a school environment;
providing access by the user to the user groups based upon the user groups and the user role assigned to the user; and
identifying the user by a real name of the user.

5. A method of creating and providing access to a student digital portfolio that aggregates and centralizes information about a student in a school for collaboration among school staff, comprising the steps of:
receiving first student information from teachers of the student;
storing the student information;
receiving second student information from a student information system for the school;
providing a digital drop box for the input by the student of student work;
storing a student plan for the student created by the school staff;
aggregating the first student information, the second student information, the student work and the student plan based upon identify of the student and schedule information relating to the student from the student information system; and
providing access to the school staff to the aggregated information.
